(19) United States
(12) Patent Application Publication
(10) Pub. No.: US 2003/0027736 A1
(43) Pub. Date: Feb. 6, 2003

(54) Hydroxy mixed ethers with high degree of ethoxylation

(76) Inventors: Hans-Christian Raths, Monheim (DE); Manfred Weuthen, Langenfeld (DE); Michael Elsner, Heiligenhaus (DE); Detlev Stanislowski, Mettmann (DE); Karl-Heinz Schmid, Mettmann (DE)

Correspondence Address: COGNIS CORPORATION, 2500 RENAISSANCE BLVD., SUITE 200, GULPH MILLS, PA, 19406

(21) Appl. No.: 10/056,604

(22) Filed: Jan. 24, 2002

(30) Foreign Application Priority Data
Feb. 1, 2001 (DE) DE 101 04 368.6
Mar. 13, 2001 (DE) DE 101 11 838.4

(51) Int. Cl. C11D 1/00

(52) U.S. Cl. 510/220; 568/606; 510/224

(57) ABSTRACT

The invention relates to highly ethoxylated hydroxy mixed ethers, alone or in conjunction with customary detergent and cleaning product ingredients, together if desired with further nonionic surfactants and anionic surfactants, and to the use of such hydroxy mixed ethers for improving wetting behavior and plastics compatibility.

### FIELD OF THE INVENTION

The invention relates to highly ethoxylated hydroxy mixed ethers, alone or in conjunction with customary detergent and cleaning product ingredients, together if desired with further nonionic surfactants and anionic surfactants, and to the use of such hydroxy mixed ethers for improving wetting behavior and plastics compatibility.

### PRIOR ART

Compositions for washing and cleaning hard nontextile surfaces in the household and commercial sector are generally intended to develop a small foam volume on use, which further reduces significantly within a few minutes. Compositions of this kind have been known for a long time and are established on the market. They essentially comprise aqueous surfactant solutions of different kinds with or without the addition of builders, solubilizers (hydrotropes) or solvents. At the beginning of cleaning work, the consumer does in fact desire a certain foaming of the application solution, for the purpose of demonstrating effectiveness, but the foam ought rapidly to collapse so that areas once cleaned need not be wiped again. For this purpose, the compositions of the type mentioned are normally formulated with low-foaming nonionic surfactants.

For machine-washed kitchen- and tableware, more stringent requirements are nowadays imposed than for handwashed ware. For instance, even ware fully cleaned of its food residues is considered imperfect if, following machine washing, it still has whitish spots, originating from water hardness or other mineral salts, which derive from dried-on water droplets for lack of wetting agents. In order to obtain spotless ware with a clear luster, therefore, rinse aids are used. The addition of liquid or solid rinse aid, which may be added separately or may already be present in a ready-to-use presentation form together with the detergent and/or regenerating salt (“2 in 1”, “3 in 1”, e.g., in the form of tabs and powders), ensures that the water runs off as fully as possible from the ware so that at the end of the wash program the various surfaces are lustrous and free from residue.

Customary commercial rinse agents constitute mixtures of, for example, nonionic surfactants, solubilizers, organic acids and solvents, water and, where appropriate, preservatives and fragrances. The function of the surfactants in these compositions is to influence the surface tension of water in such a way that it is able to run off in an extremely thin coherent film from the ware so that no water droplets, streaks or films remain in the subsequent drying process (the effect or behavior referred to as wetting).

Accordingly, surfactants in rinse aids are also required to suppress the foam which occurs as a result of food residues in the dishwasher. Since the rinse aids usually include acids for enhancing the dry-clear effect, the surfactants used must also be relatively hydrolysis-insensitive to acids.

Rinse aids are used both in the household and in the commercial sector. In domestic dishwashers, the rinse aid is normally metered in after the prewash cycle and cleaning cycle at just 40° C.-65° C. The commercial dishwashers operate with only one wash liquor, which is refreshed only by addition of the rinse solution from the preceding wash. Throughout the entire wash program, therefore, the water is never completely replaced. Accordingly, the rinse aid must also have a foam suppressing effect, must be temperature-safe with a sharp temperature gradient of 85-35° C., and must also be sufficiently stable toward alkali and active chlorine.

The German laid-open specification DE 19738866 describes surfactant mixtures comprising hydroxy mixed ethers and nonionic surfactants, such as fatty alcohol polyethylene glycol/polypropylene glycol ethers, where appropriate with end group capping, which exhibit very good foaming behavior and display outstanding rinse-clear effects in rinse agents.

From the German laid-open specification DT 2432757 it is known that hydroxy mixed ethers are used as foam suppressants in detergents and cleaning products.

It was an object of the present invention to provide detergents and cleaning products which combine good foaming and cleaning behavior, and in particular a very good runoff behavior, i.e., an improvement in the wetting behavior on plastic surfaces, with high material compatibility, particularly with plastics. Moreover, it ought to be easier to prepare solid cleaning formulations.

The object has been achieved by using selected surfactants of the hydroxy mixed ether type.

### DESCRIPTION OF THE INVENTION

The invention provides hydroxy mixed ethers (HMEs) of the formula (I)

R¹O[CH₂CH₂O]ₓCH₂CH(O)R² (I)

in which R¹ stands for a linear or branched alkyl and/or alkenyl radical having from 4 to 22 carbon atoms,

R² stands for a linear or branched alkyl and/or alkenyl radical having from 2 to 22 carbon atoms, and

x is from 40 to 80.

Hydroxy Mixed Ethers

Hydroxy mixed ethers are known from the literature and are described, for example, in the German application DE 19738866.

They are prepared by reacting 1,2-epoxyalkanes (R²CHOCH₂) in which R² stands for an alkyl and/or alkenyl radical having from 2 to 22, in particular from 6 to 16, carbon atoms with alkoxylated alcohols. Preference is given in the context of the invention to those hydroxy mixed ethers which derive from alkoxylates of monohydric alcohols of the formula R¹-OH having from 4 to 18 carbon atoms in which R¹ stands for an aliphatic, saturated, straight-chain or branched alkyl radical, in particular having from 6 to 16 carbon atoms.

Examples of suitable straight-chain alcohols are 1-butanol, caproyl, enanthyl, caprylyl, pelargonyl, and capryl alcohol, 1-undecanol, lauryl alcohol, 1-tri-decanol, myristyl alcohol, 1-pentadecanol, palmityl alcohol, 1-heptadecanol, stearyl alcohol, 1-nona-decanol, arachidyl alcohol, 1-heneicosanol, behenyl alcohol, and their technical-grade mixtures, such as are produced in the high-pressure hydrogenation of technical-grade methyl esters based on fats and oils. Examples of branched alcohols are those known as oxo alcohols, which carry usually from 2 to 4 methyl group branches and are prepared by the oxo process, and those known as guerbet alcohols, which are branched with an alkyl group in position 2. Suitable guerbet alcohols are 2-ethylhexanol, 2-butyloctanol, 2-hexyldecanol and/or 2-octyldodecanol.

The alcohols are used in the form of their alkoxylates, which are prepared conventionally by reacting the alcohols in with ethylene oxide.

It is preferred to use alkoxylates of alcohols formed by reaction with from 40 to 80 mol of ethylene oxide. Particular preference is given to hydroxy mixed ethers having from 40 to 60 ethylene oxide units.

Preference in the context of the invention is given to those hydroxy mixed ethers which derive from ethoxylates of monohydric alcohols of the formula R¹—OH having from 6 to 18 carbon atoms, preferably from 6 to 16 and in particular from 8 to 10 carbon atoms, in which R¹ stands for a linear alkyl radical and x is from 40 to 60.

Very particular preference is given to hydroxy mixed ethers of the formula (I) in which R1 stands for an alkyl radical having from 8 to 10 carbon atoms, based in particular on a natural fatty alcohol, R2 stands for an alkyl radical having 10 carbon atoms, in particular for a linear alkyl radical, and x is from 40 to 60.

In a further embodiment, compositions are claimed which comprise hydroxy mixed ethers of the invention and also further customary detergent and cleaning product ingredients. As described below, these customary ingredients may be alkyl and/or alkenyl oligoglycosides, further nonionic surfactants, anionic surfactants, builders, enzymes, and other auxiliaries and additives.

Alkyl and/or Alkenyl Oligoglycosides

In a further embodiment, the compositions of the invention comprise alkyl and/or alkenyl oligoglycosides of the formula (II)

R⁵O—[G]ₚ (II)

in which R⁵ stands for an alkyl and/or alkenyl radical having 4 to 22 carbon atoms, G for a sugar radical having 5 or 6 carbon atoms, and p for numbers from 1 to 10, are present.

They may be obtained by the relevant processes of preparative organic chemistry. As representatives of the extensive literature, reference may be made here to the review work by Biermann et al. in Starch/Stärke 45, 281 (1993), B. Salka in Cosm. Toil. 108, 89 (1993), and also J. Kahre et al. in SÖFW-Journal volume 8, 598 (1995).

The alkyl and/or alkenyl oligoglycosides may derive from aldoses and/or ketoses having 5 or 6 carbon atoms, preferably from glucose. The preferred alkyl and/or alkenyl oligoglycosides are therefore alkyl and/or alkenyl oligoglucosides.

The alkyl radical R⁵ may derive from primary saturated alcohols. Typical examples are 1-butanol, caproyl, enanthyl, caprylyl, pelargonyl, and capryl alcohol, 1-undecanol, lauryl alcohol, 1-tridecanol, myristyl alcohol, 1-pentadecanol, cetyl alcohol, palmityl alcohol, 1-heptadecanol, stearyl alcohol, isostearyl alcohol, 1-nonadecanol, arachidyl alcohol, 1-heneicosanol, and behenyl alcohol, and also their technical-grade mixtures, as obtained, for example, in the hydrogenation of technical-grade fatty acid methyl esters or in the course of the hydrogenation of aldehydes from the Roelen oxo process.

The alkenyl radical R⁵ may derive from primary unsaturated alcohols. Typical examples of unsaturated alcohols are undecen-1-ol, oleyl alcohol, elaidyl alcohol, ricinoleyl alcohol, linoleyl alcohol, linolenyl alcohol, gadoleyl alcohol, arachidonyl alcohol, erucyl alcohol, brassidyl alcohol, palmoleyl alcohol, petroselinyl alcohol, arachyl alcohol, and also their technical-grade mixtures, which may be obtained as described above.

Preference is given to alkyl and/or alkenyl radical R⁵ which derive from primary alcohols having from 6 to 16 carbon atoms.

Particularly suitable are alkyl oligoglucosides of chain length C₈-C₁₀ which are obtained as an initial fraction in the distillative separation of technical-grade C₈-C₁₈ coconut fatty alcohol and may have an impurities fraction of less than 6% by weight of C₁₂ alcohol, and also alkyl oligoglucosides based on technical-grade C_{9/11} oxo alcohols.

The alkyl and/or alkenyl radical R⁵ may further derive from primary alcohols having from 12 to 14 carbon atoms.

The index p in the general formula (II) indicates the degree of oligomerization (DP), i.e., the distribution of monoglycosides and oligoglycosides, and stands for a number between 1 and 10. While p in a given compound must always be integral and in this case may adopt in particular the values p=1 to 3, the value p for a particular alkyl oligoglycoside is an analytically determined arithmetic variable which usually represents a fractional number.

Preference is given to using alkyl and/or alkenyl oligoglycosides having an average degree of oligomerization p of from 1.1 to 2.0. From a performance standpoint, preference is given to those alkyl and/or alkenyl oligoglycosides whose degree of oligomerization is less than 2.0 and is in particular between 1.2 and 1.7.

It is preferred to use alkyl and/or alkenyl oligoglycosides of the formula (II) in which p stands for numbers from 1 to 3 and R⁵ stands for an alkyl radical having from 6 to 16 carbon atoms.

In one preferred embodiment the compositions of the invention contain from 0.01 to 25% by weight, preferably from 0.025 to 20% by weight, and in particular from 0.1 to 15% by weight of hydroxy mixed ethers of the formula (I) calculated as active substance, based on the compositions.

Active substance is defined as the mass of surfactants (calculated as pure material at 100%) which are present in the composition.

In a further embodiment the compositions of the invention contain from 0.01 to 30% by weight, preferably from 0.1 to 20% by weight, and in particular from 0.2 to 15% by weight of alkyl and/or alkenyl oligoglycosides of the formula (II) calculated as active substance, based on the compositions.

Nonionic Surfactants

The compositions of the invention may comprise further nonionic surfactants. Typical examples of nonionic surfactants are alkoxylates of alkanols, endgroup-capped alkoxylates of alkanols without free OH groups, alkoxylated fatty acid lower alkyl esters, amine oxides, alkylphenol polyglycol ethers, fatty acid polyglycol esters, fatty acid amide polyglycol ethers, fatty amine polyglycol ethers, alkoxylated triglycerides, mixed ethers and mixed formals, fatty acid N-alkylglucamides, protein hydrolysates (particularly plant products based on wheat), polyol fatty acid esters, sugar esters, sorbitan esters, and polysorbates. Where the nonionic surfactants contain polyglycol ether chains, these may have a conventional but preferably have a narrowed homolog distribution. Preferably the further nonionic surfactants are selected from the group formed by alkoxylates of alkanols, especially fatty alcohol polyethylene glycol/polypropylene glycol ethers (FAEO/PO) of the formula (III) and fatty alcohol polypropylene glycol/polyethylene glycol ethers (FAPO/EO) of the formula (IV), endgroup-capped alkoxylates of alkanols, especially endgroup-capped fatty alcohol polyethylene glycol/polypropylene glycol ethers and endgroup-capped fatty alcohol polypropylene glycol/polyethylene glycol ethers, and fatty acid lower alkyl esters and amine oxides.

Fatty Alcohol Polyethylene Glycol/Polypropylene Glycol Ethers

In one preferred embodiment use is made of fatty alcohol polyethylene glycol/polypropylene glycol ethers of the formula (III), with or without end group capping,

R⁶O(CH₂CH₂O)ₙ[CH₂(CH₃)CHO]ₘR⁷ (III)

in which R⁶ stands for an alkyl and/or alkenyl radical having from 8 to 22 carbon atoms, R⁷ for H or an alkyl radical having from 1 to 8 carbon atoms, n for a number from 1 to 40, preferably from 1 to 30, in particular from 1 to 15, and m for 0 or a number from 1 to 10.

Fatty Alcohol Polypropylene Glycol/Polyethylene Glycol Ethers

Likewise suitable are fatty alcohol polypolypropylene glycol/polyethylene glycol ethers of the formula (IV), with or without end group capping,

R⁸O[CH₂(CH₃)CHO]_{q}(CH₂CH₂O)ᵣR⁹ (IV)

in which R⁸ stands for an alkyl and/or alkenyl radical having from 8 to 22 carbon atoms, R⁹ for H or an alkyl radical having from 1 to 8 carbon atoms, q for a number from 1 to 5, and r for a number from 0 to 15.

In accordance with one preferred embodiment, the compositions of the invention comprise fatty alcohol polyethylene glycol/polypropylene glycol ethers of the formula (III) in which R⁶ stands for an aliphatic, saturated, straight-chain or branched alkyl radical having from 8 to 16 carbon atoms, n for a number from 1 to 10, and m for 0 and R⁷ for hydrogen. These are adducts of from 1 to 10 mol of ethylene oxide with monofunctional alcohols. Suitable alcohols are the above-described alcohols such as fatty alcohols, oxo alcohols and guerbet alcohols.

Also suitable are, among such alcohol ethoxylates, those which have a narrowed homolog distribution.

Further suitable representatives of endgroup-uncapped representatives are those of the formula (III) in which R⁶ stands for an aliphatic, saturated, straight-chain or branched alkyl radical having from 8 to 16 carbon atoms, n for a number from 2 to 7, m for a number from 3 to 7, and R⁷ for hydrogen. These are adducts of monofunctional alcohols of the type already described alkoxylated first with from 2 to 7 mol of ethylene oxide and then with from 3 to 7 mol of propylene oxide.

The endgroup-capped compounds of the formula (III) are capped with an alkyl group having from 1 to 8 carbon atoms (R⁷). In many cases, compounds of this kind are referred to in the literature as mixed ethers. Suitable representatives are methyl-capped compounds of the formula (III) in which R⁶ stands for an aliphatic, saturated, straight-chain or branched alkyl radical having from 8 to 16 carbon atoms, n for a number from 2 to 7, m for a number from 3 to 7, and R⁷ for a methyl group. Compounds of this kind can be prepared easily by reacting the corresponding endgroup-uncapped fatty alcohol polyethylene glycol/polypropylene glycol ethers with methyl chloride in the presence of a base.

Suitable representatives of alkyl-capped compounds are those of the formula (III) in which R⁶ stands for an aliphatic, saturated, straight-chain or branched alkyl radical having from 8 to 16 carbon atoms, n for a number from 5 to 15, m for 0, and R⁷ for an alkyl group having from 4 to 8 carbon atoms. Preferably, endgroup capping is carried out with a straight-chain or branched butyl group by reacting the corresponding fatty alcohol polyethylene glycol ether with n-butyl chloride or with tert-butyl chloride in the presence of bases.

Instead of the compounds of the formula (III) or in a mixture with them it is possible if desired for endgroup-capped fatty alcohol polypropylene glycol/polyethylene glycol ethers of the formula (IV) to be present. Compounds of this kind are described, for example, in the German laid-open specification DE-A1-4323252. Particularly preferred representatives of the compounds of the formula (IV) are those in which R⁸ stands for an aliphatic, saturated, straight-chain or branched alkyl radical having from 8 to 16 carbon atoms, q for a number from 1 to 5, r for a number from 1 to 6, and R⁹ for hydrogen. They are preferably adducts of from 1 to 5 mol of propylene oxide and of from 1 to 6 mol of ethylene oxide with monofunctional alcohols, which have already been described as being suitable in connection with the hydroxy mixed ethers.

Alkoxylated Fatty Acid Lower Alkyl Esters

Suitable alkoxylated fatty acid lower alkyl esters include surfactants of the formula (V)

R¹⁰CO—(OCH₂CHR¹¹)_{w}OR¹² (V)

in which R¹⁰CO stands for a linear or branched, saturated and/or unsaturated acyl radical having from 6 to 22 carbon atoms, R¹¹ for hydrogen or methyl, R¹² for linear or branched alkyl radicals having from 1 to 4 carbon atoms, and w for numbers from 1 to 20. Typical examples are the formal insertion products of on average from 1 to 20 and preferably from 5 to 10 mol of ethylene oxide and/or propylene oxide into the methyl, ethyl, propyl, isopropyl, butyl, and tert-butyl esters of caproic acid, caprylic acid, 2-ethylhexanoic acid, capric acid, lauric acid, isotridecanoic acid, myristic acid, palmitic acid, palmoleic acid, stearic acid, isostearic acid, oleic acid, elaidic acid, petroselinic acid, linoleic acid, linolenic acid, elaeostearic acid, arachic acid, gadoleic acid, behenic acid, and erucic acid, and also their technical-grade mixtures. The products are normally prepared by inserting the alkylene oxides into the carbonyl ester linkage in the presence of specific catalysts, such as calcined hydrotalcite, for example. Particular preference is given to reaction products of on average from 5 to 10 mol of ethylene oxide into the ester linkage of technical-grade coconut fatty acid methyl esters.

Amine Oxides

As amine oxides it is possible to use compounds of the formula (VI) and/or (VII).

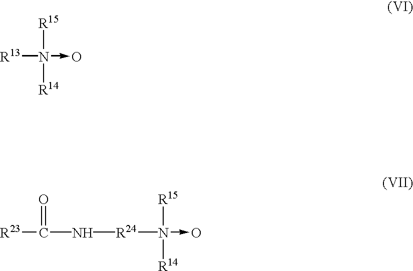

The preparation of the amine oxides of the formula (VI) involves starting from tertiary fatty amines containing at least one long alkyl radical and oxidizing them in the presence of hydrogen peroxide. In the amine oxides of the formula (VI) that are contemplated in the context of the invention, R¹³ stands for a linear or branched alkyl radical having from 6 to 22, preferably from 12 to 18, carbon atoms, and R¹⁴ and R¹⁵ stand independently of one another for R¹³ or an optionally hydroxy-substituted alkyl radical having from 1 to 4 carbon atoms. It is preferred to use amine oxides of the formula (VI) in which R¹³ and R¹⁴ stand for C_{12/14} and/or C_{12/18} cocoalkyl radicals and R¹⁵ denotes a methyl or a hydroxyethyl radical. Likewise preferred are amine oxides of the formula (VI) in which R¹³ stands for C_{12/14} and/or C_{12/18} cocoalkyl radicals and R¹⁴ and R¹⁵ have the definition of a methyl or hydroxyethyl radical.

Further suitable amine oxides are alkylamido-amine oxides of the formula (VII) in which the alkylamido radical R²³CONH comes about through the reaction of linear or branched carboxylic acids, preferably having from 6 to 22, more preferably having from 12 to 18, carbon atoms, in particular of C_{12/14} and/or C_{12/18} fatty acids with amines. R²⁴ represents a linear or branched alkylene group having from 2 to 6, preferably from 2 to 4, carbon atoms and R¹⁴ and R¹⁵ have the definition indicated in formula (VI).

The further nonionic surfactants may be present in the compositions of the invention in amounts of from 0.1 to 15% by weight, preferably from 0.5 to 10% by weight, in particular from 1 to 8% by weight, calculated as active substance, based on the compositions.

In accordance with the present invention, the compositions of the invention may comprise anionic surfactants.

Anionic Surfactants

Typical examples of anionic surfactants are soaps, alkylbenzenesulfonates, secondary alkanesulfonates, olefinsulfonates, alkyl ether sulfonates, glycerol ether sulfonates, α-methyl ester sulfonates, sulfo fatty acids, alkyl and/or alkenyl sulfates, alkyl ether sulfates, glycerol ether sulfates, hydroxymixed ether sulfates, monoglyceride (ether) sulfates, fatty acid amide (ether) sulfates, mono- and dialkyl sulfo-succinates, mono- and dialkyl sulfosuccinamates, sulfo-triglycerides, amide soaps, ether carboxylic acids and salts thereof, fatty acid isethionates, fatty acid sarcosinates, fatty acid taurides, N-acyl amino acids such as, for example, acyl lactylates, acyl tartrates, acyl glutamates and acyl aspartates, alkyl oligo-glucoside sulfates, protein fatty acid condensates (especially plant products based on wheat), and alkyl (ether) phosphates. Where the anionic surfactants contain polyglycol ether chains, these chains may have a conventional or, preferably, a narrowed homolog distribution.

Preferred anionic surfactants are selected from the group formed by alkyl and/or alkenyl sulfates, alkyl ether sulfates, alkylbenzenesulfonates, monoglyceride (ether) sulfates and alkanesulfonates, especially fatty alcohol sulfates, fatty alcohol ether sulfates, secondary alkanesulfonates, and linear alkylbenzene-sulfonates.

Alkyl and/or Alkenyl Sulfates

Alkyl and/or alkenyl sulfates, frequently also referred to as fatty alcohol sulfates, are the sulfation products of primary alcohols, conforming to the formula (VIII)

R¹⁶O—SO₃X (VIII)

in which R¹⁶ is a linear or branched, aliphatic alkyl and/or alkenyl radical having from 6 to 22, preferably from 12 to 18, carbon atoms, and X is an alkali metal and/or alkaline earth metal, ammonium, alkylammonium, alkanolammonium or glucammonium.

Typical examples of alkyl sulfates that may be used in the context of the invention are the sulfation products of caproyl alcohol, caprylyl alcohol, capryl alcohol, 2-ethylhexyl alcohol, lauryl alcohol, myristyl alcohol, cetyl alcohol, palmoleyl alcohol, stearyl alcohol, isostearyl alcohol, oleyl alcohol, elaidyl alcohol, petroselinyl alcohol, arachyl alcohol, gadoleyl alcohol, behenyl alcohol, and erucyl alcohol, and also their technical-grade mixtures obtained by high-pressure hydrogenation of industrial methyl ester fractions or aldehydes from the Roelen oxo process. The sulfation products may be used preferably in the form of their alkali metal salts and in particular of their sodium salts. Particular preference is given to alkyl sulfates based on C_{16/18} tallow fatty alcohols or vegetable fatty alcohols of comparable carbon chain distribution in the form of their sodium salts.

Alkyl Ether Sulfates

Alkyl ether sulfates (“ether sulfates”) constitute known anionic surfactants which are prepared industrially by SO₃ or chlorosulfonic acid (CSA) sulfation of fatty alcohol or oxo alcohol polyglycol ethers and subsequent neutralization. Ether sulfates suitable in the context of the invention are those which conform to the formula (IX)

R¹⁷O—(CH₂ CH₂O)ₐSO₃X (IX)

in which R¹⁷ is a linear or branched alkyl and/or alkenyl radical having from 6 to 22 carbon atoms, a stands for numbers from 1 to 10, and X is an alkali metal and/or alkaline earth metal, ammonium, alkylammonium, alkanol-ammonium or glucammonium. Typical examples are the sulfates of adducts of on average from 1 to 10 and in particular from 2 to 5 mol of ethylene oxide with caproyl alcohol, caprylyl alcohol, 2-ethylhexyl alcohol, capryl alcohol, lauryl alcohol, isotridecyl alcohol, myristyl alcohol, cetyl alcohol, palmoleyl alcohol, stearyl alcohol, isostearyl alcohol, oleyl alcohol, elaidyl alcohol, petroselinyl alcohol, arachyl alcohol, gadoleyl alcohol, behenyl alcohol, erucyl alcohol, and brassidyl alcohol, and also their technical-grade mixtures in the form of their sodium and/or magnesium salts. The ether sulfates may have either a conventional or a narrowed homolog distribution. Particularly preferred is the use of ether sulfates based on adducts of on average from 2 to 3 mol of ethylene oxide with technical-grade C_{12/14} and/or C_{12/18} coconut fatty alcohol fractions in the form of their sodium and/or magnesium salts.

Alkylbenzenesulfonates

Alkylbenzenesulfonates conform preferably to the formula (X)

R¹⁸—Ph—SO₃X (X)

in which R¹⁸ is a branched or, preferably, linear alkyl radical having from 10 to 18 carbon atoms, Ph is a phenyl radical, and X is an alkali metal and/or alkaline earth metal, ammonium, alkylammonium, alkanolammonium or glucammonium. Preference is given to using dodecylbenzenesulfonates, tetradecylbenzenesulfonates, hexadecylbenzenesulfonates, and their technical-grade mixtures in the form of the sodium salts.

Monoglyceride (Ether) Sulfates

Monoglyceride sulfates and monoglyceride ether sulfates constitute known anionic surfactants which may be obtained in accordance with the relevant methods of preparative organic chemistry. They are usually prepared starting from triglycerides, which as they are or following ethoxylation are transesterified to the mono-glycerides and subsequently sulfated and neutralized. It is likewise possible to react the partial glycerides with suitable sulfating agents, preferably gaseous sulfur trioxide or chlorosulfonic acid [cf. EP 0561825 B1, EP 0561999 B1 (Henkel)]. The neutralized substances may, if desired, be subjected to ultrafiltration in order to reduce the electrolyte content to a desired level [DE 4204700 A1 (Henkel)]. Reviews of the chemistry of the monoglyceride sulfates have appeared, for example, from A. K. Biswas et al. in J. Am. Oil. Chem. Soc. 37, 171 (1960) and F. U. Ahmed J. Am. Oil. Chem. Soc. 67, 8 (1990). The monoglyceride (ether) sulfates for use in the context of the invention conform to the formula (XI)

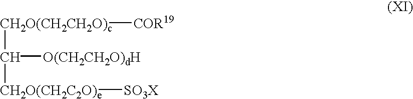

in which R¹⁹CO is a linear or branched acyl radical having from 6 to 22 carbon atoms, c, d and e in total stand for 0 or for numbers from 1 to 30, preferably from 2 to 10, and X is an alkali metal or alkaline earth metal. Typical examples of monoglyceride (ether) sulfates suitable in the context of the invention are the reaction products of lauric monoglyceride, coconut fatty acid monoglyceride, palmitic monoglyceride, stearic monoglyceride, oleic monoglyceride and tallow fatty acid monoglyceride, and also their ethylene oxide adducts with sulfur trioxide or chlorosulfonic acid in the form of their sodium salts. It is preferred to use monoglyceride sulfates of the formula (XI) in which R¹⁹CO is a linear acyl radical having from 8 to 18 carbon atoms.

Alkanesulfonates

By alkanesulfonates are meant compounds of the formula (XII).

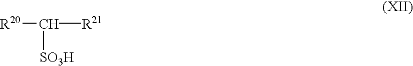

R²⁰ and R²¹ stand for alkyl radicals, and R²⁰ and R²¹ together should have not more than 50 carbon atoms.

Appropriately the compositions may contain from 0.1 to 20% by weight, preferably from 0.25 to 15% by weight, in particular from 0.4 to 10% by weight of anionic surfactants, calculated as active substance, based on the compositions. The remainder to 100% by weight may be represented by auxiliaries and additives and also water.

As customary ingredients or auxiliaries and additives, the compositions of the invention may contain for example solubilizers such as cuminesulfonate, ethanol, isopropyl alcohol, ethylene glycol, propylene glycol, butyl glycol, diethylene glycol, propylene glycol monobutyl ether, polyethylene and/or polypropylene glycol ethers having molar masses of from 600 to 1 500 000, preferably having a molar mass of from 400 000 to 800 000, or in particular butyl diglycol. It is also possible for abrasives, such as quartz flour or wood flour or polyethylene abrasives, to be present. In many cases, an additional bactericidal effect is desired, and so the compositions may include cationic surfactants or biocides, an example being glucoprotamine.

Suitable builders are zeolites, phyllosilicates, phosphates, and also ethylenediaminetetraacetic acid, nitrilotriacetic acid, citric acid and the salts thereof, and also inorganic phosphonic acids.

Among the compounds which act as peroxy bleaches, particular importance is possessed by sodium perborate tetrahydrate and sodium perborate monohydrate. Examples of further bleaches are peroxycarbonate, citrate perhydrates, and H₂O₂-providing peracidic salts of peracids such as perbenzoates, peroxyphthalates or diperoxydodecanedioic acid. They are usually used in amounts of from 0.1 to 40% by weight. Preference is given to the use of sodium perborate monohydrate in amounts of from 10 to 20% by weight and in particular from 10 to 15% by weight.

Suitable enzymes include those from the class of the proteases, lipase, amylases, cellulases, and mixtures thereof. Especially suitable active enzymatic substances are those obtained from bacterial strains or fungi, such as Bacillus subtilis, Bacillus lichenformis and Strptomyces griseus. It is preferred to use proteases of the subtilisin type, and especially proteases obtained from Bacillus lentes. Their fraction may amount to from about 0.1 to 6%, preferably from 0.2 to 2%, by weight. The enzymes may be adsorbed on carrier substances or embedded in coating substances in order to protect them against premature decomposition.

In addition to monofunctional and polyfunctional alcohols and phosphonates, the compositions may comprise further enzyme stabilizers. For example, from 0.5 to 1% by weight of sodium formate may be used. Also possible is the use of proteases stabilized with soluble calcium salts, with a calcium content of preferably about 1.2% by weight, based on the enzyme. However, it is particularly advantageous to use boron compounds, examples being boric acid, boron oxide, borax, and other alkali metal borates such as the salts of orthoboric acid (H₃BO₃), of metaboric acid (HBO₂), and of pyroboric acid (tetraboric acid H₂B₄O₇).

In the context of use in machine laundering processes, it may be of advantage to add customary foam inhibitors to the compositions. Suitable foam inhibitors contain, for example, known organoolysiloxanes and/or paraffins or waxes. Also present, moreover, may be foam regulators, such as soap, fatty acids, especially coconut fatty acid and palm kernel fatty acid, for example.

As thickeners it is possible, for example, to use hydrogenated castor oil, salts of long-chain fatty acids, which are used preferably in amounts of from 0 to 5% by weight and in particular amounts of from 0.5 to 2% by weight, examples being sodium, potassium, aluminum, magnesium and titanium stearates or the sodium and/or potassium salts of behenic acid, and further polymeric compounds. The latter preferably include polyvinylpyrrolidone, urethanes, and the salts of polymeric polycarboxylates, examples being homopolymeric or copolymeric polyacrylates, polymethacrylates and, in particular, copolymers of acrylic acid with maleic acid, preferably those composed of from 50 to 10% by weight of maleic acid. The relative molecular mass of the homopolymers is generally between 1,000 and 100,000, that of the copolymers between 2,000 and 200,000, preferably between 50,000 to 120,000, based on the free acid. In particular, water-soluble polyacrylates are also suitable which are crosslinked, for example, with about 1% of a polyallyl ether of sucrose and which possess a relative molecular mass of more than 1,000,000. Examples of these are polymers obtainable under the name CARBOPOL® 940 and 941. The crosslinked polyacrylates are used preferably in amounts of not more than 1% by weight with particular preference in amounts of from 0.2 to 0.7% by weight.

In a further embodiment, preference is given to compositions, particularly for automatic dishwashers, which contain from 0.1 to 15%, preferably from 0.5 to 12%, by weight of surfactants which include hydroxy mixed ethers of the formula (I), especially those having a degree of ethoxylation x=40 to 60, capped with an epoxide having a total of 12 carbon atoms (R2=10), generated from a natural fatty alcohol having from 8 to 10 carbon atoms. The compositions of the invention further contain from 5 to 90%, preferably from 10 to 80%, by weight of builders, from 0.1 to 6% by weight of cleaning product enzyme, optionally from 0.1 to 40%, preferably from 0.5 to 30%, by weight of bleaches and auxiliaries and additives. % by weight is to be understood as being based on the composition. The present invention further provides for the use of hydroxy mixed ethers of the formula (I) in detergents and cleaning products, especially for washing and cleaning hard surfaces, preferably within the home and in the industrial and institutional sector. Particularly appropriate is their use in ware cleaners, rinse aids, bathroom cleaners, floor cleaners, cleaners in accordance with the clean shower concept (e.g., bathroom cleaner which is sprayed onto walls and fittings before and after showering so that water and soap residues run off more effectively and so subsequent wiping is unnecessary), cockpit cleaners (automobile, aircraft, boat, motorbike), window cleaners and all-purpose cleaners. Hard surfaces include ceramic areas, metal areas, painted areas, plastics surfaces, and surfaces of glass, stone, concrete, porcelain, and wood.

Particular preference is given to the use of the hydroxy mixed ethers of the invention of the formula (I) for improving the wetting behavior in detergents and cleaning products, preferably on hard surfaces, especially in machine dishwashing detergents and/or rinse aids.

Further preferred is the use of hydroxy mixed ethers of the formula (I) for improving plastics compatibility in detergents and cleaning products, especially in machine dishwashing detergents and/or rinse aids.

Preference is also given to the use of hydroxy mixed ethers of the formula (I) in combination with alkyl and/or alkenyl oligoglycosides in the areas of cleaning listed up to now.

Very particular preference attaches to the hydroxy mixed ethers of the invention of the formula (I), alone or in combination with the other surfactants already described, for the simplified preparation of solid cleaner formulations. Because of their relatively high melting points, the hydroxy mixed ethers of the invention are easier to incorporate into detergent and cleaning product formulations, particularly into solid cleaners.

Unlike the hydroxy mixed ethers known to date, the more highly ethoxylated products are notable, in addition to their foam-suppressing action and high compatibility, in particular with respect to plastics, for their higher melting points. As a result, they are especially suitable for the simplified preparation of solid formulations. Similarly, owing to their higher melting points, these hydroxy mixed ethers dissolve later in the cleaning liquor and develop their activity with a time offset and in a higher concentration. This effect may be utilized with particular advantage in rinse aid applications. Surprisingly, the hydroxy mixed ethers of the invention are especially notable for their colorless, clear appearance, which is a prerequisite for incorporation into a large number of detergents and cleaning products without an expensive bleaching process.

### EXAMPLES

Screening Method for Evaluating the Wetting Properties of Surfactant Solutions for Plastics Materials

The wetting properties of surfactant solutions for plastics were determined in a simplified screening process in accordance with the conditions/test parameters in a commercially customary machine dishwasher, but without using such a machine.

In order to evaluate the wetting properties, plastic test specimens measuring 20×5 cm are cleaned first with 1% strength NaOH and then with isopropanol. The test specimens pretreated in this way are then immersed in the test solution and removed again directly. Evaluation is carried out visually by compiling an ordered list and in accordance with a ratings scale from 1-5. 5 here means that the liquid film breaks open spontaneously and wetting is completely eliminated. Rating 5 is obtained when using water. Rating 1 denotes complete wetting of the plastics surface with uniform runoff of the liquid film. Rating 1 is obtained when using Na-LAS (e.g., Maranil A 55/COGNIS).

Test Parameters:

| Water hardness: | 2° d [German hardness] |
|---|---|
| Salt load: | 700 ppm |
| Temperature: | 60° C. |
| Surfactant concentration: | 0.1% |

Test Specimens:

PP (polypropylene); PE (polyethylene); PC (polycarbonate)

Table 1 shows the test results, with V1 to V4 showing comparative tests and I, II, and II showing the inventive examples.

TABLE 1
Wetting properties on plastics

| Composition in % | | | | | | | |
|---|---|---|---|---|---|---|---|
| active substance | V1 | V2 | V3 | V4 | I | II | III |
| Fatty alcohol C8-C10 + | — | — | — | — | — | — | 0.1 |
| 60EO − 2-hydroxydodecyl | | | | | | | |
| ether | | | | | | | |
| Fatty alcohol C8-C10 + | — | — | — | — | — | 0.1 | — |
| 40EO − 2-hydroxydodecyl | | | | | | | |
| ether | | | | | | | |
| Fatty alcohol C8-C10 + | — | — | — | — | 0.1 | — | — |
| 30EO − 2-hydroxydodecyl | | | | | | | |
| ether | | | | | | | |
| Fatty alcohol C8-C10 + | — | — | — | 0.1 | — | — | — |
| 10EO − 2-hydroxydodecyl | | | | | | | |
| ether | | | | | | | |
| Poly Tergent SLF-18B-45* | — | — | 0.1 | — | — | — | — |
| Maranil A 55 (Na-LAS) | — | 0.1 | — | — | — | — | — |
| Water, 2° d/700 ppm NaCl | 100 | 99.9 | 99.9 | 99.9 | 99.9 | 99.9 | 99.9 |
| Wetting properties on | | | | | | | |
| plastics | | | | | | | |
| Temperature: | 5 | 1 | 3 | 4 | 3 | 2 | 3 |
| 60° C./plastic “PP” | | | | | | | |
| Temperature: | 5 | 1 | 3 | 4 | 3 | 2 | 3 |
| 60° C./plastic “PE” | | | | | | | |
| Temperature: | 5 | 1 | 4 | 3 | 2 | 2 | 3 |
| 60° C./plastic “PC” | | | | | | | |

*alcohol alkoxylate from Olin Chemicals with 1 PO and 22 EO,

In the stress crack corrosion test, the plastic rods are briefly exposed to the test product by immersion or spraying. Adhering product is not removed. After 24 hours, spraying or immersion is repeated. In total, the plastics are exposed to the test medium 5 times. Final assessment takes place visually after 14 days. The codes are as follows:

“1”—unchanged

“2”—incipient cracking/small crack

“3”—continuous crack

“4”—fracture

The inventive examples are placed there in Table 2 under I and II.

TABLE 2
Stress crack corrosion test

| Composition in % active | | | | | |
|---|---|---|---|---|---|
| substance | V1 | V2 | V3 | I | II |
| Fatty alcohol C8-C10 + 60EO − | — | — | — | — | 5 |
| 2-hydroxydodecyl ether | | | | | |
| Fatty alcohol C8-C10 + 40EO − | — | — | — | 5 | — |
| 2-hydroxydodecyl ether | | | | | |
| Fatty alcohol C8-C10 + 10EO − | — | — | 5 | — | — |
| 2-hydroxydodecyl ether | | | | | |
| Poly Tergent SLF-18B-45* | — | 5 | — | — | — |
| Water, fully deionized | 100 | 95 | 95 | 95 | 95 |
| Stress crack corrosion test on | | | | | |
| plastics | | | | | |
| Assessment after 14 days | | | | | |
| Terez 3010 (ABS) | 1** | 4 | 4 | 3 | 2 |
| Makrolon 3103 (PC) | 1 | 3 | 3 | 2 | 2+TA,1/38 |

*alcohol alkoxylate from Olin Chemicals with 1 PO and 22 EO,

| Melting points/ranges | ° C. |
|---|---|
| Fatty alcohol C8-C10 + 60EO − | 48 |
| 2-hydroxydodecyl ether | |
| Fatty alcohol C8-C10 + 40EO − | 43 |
| 2-hydroxydodecyl ether | |
| Fatty alcohol C8-C10 + 30EO − | 38-39 |
| 2-hydroxydodecyl ether | |
| Fatty alcohol C8-C10 + 10EO − | At RT, liquid |
| 2-hydroxydodecyl ether | with turbidities |
| Poly Tergent SLF-18B-45* | 27-32 |

*: alcohol alkoxylate from Olin Chemicals with 1 P0 and 22 EO,
RT: room temperature

| | Active substance in % | | |
|---|---|---|---|
| Rinse aid formulations | 1 | 2 | 3 |
| Fatty alcohol C8-C10 + 40EO − | 12 | 6 | 5 |
| 2-hydroxydodecyl ether | | | |
| Dehypon LS 54* | | 6 | 5 |
| Glucopon 215 CSUP° | | | 2 |
| Citric acid | 5 | 5 | 5 |
| Na cumenesulfonate | 3.5 | 4.5 | 4.5 |
| Water, fully deionized | Ad 100 | | |

*: C 12-14 fatty alcohol + 5EO + 4PO
°: C 8-10 fatty alcohol polyglycoside

1. A hydroxy mixed ether of formula (I)
R¹O[CH₂CH₂O]ₓCH₂CH(O)R² (I)
in which R¹ stands for a linear or branched alkyl and/or alkenyl radical having from 4 to 22 carbon atoms,
R² stands for a linear or branched alkyl and/or alkenyl radical having from 2 to 22 carbon atoms, and
x is from 40 to 80.

2. A hydroxy mixed ether of claim 1 wherein x is from 40 to 60.

3. A composition comprising hydroxy mixed ethers of claim 1 and/or 2 and also further customary detergent and cleaning product ingredients.

4. The composition of claim 3, characterized in that it comprises hydroxy mixed ethers of formula (I) in which x is from 40 to 60.

5. The composition of claims 3 to 4, characterized in that it comprises hydroxy mixed ethers of the formula (I) in which R¹ stands for an alkyl radical having from 8 to 12 carbon atoms and R² stands for an alkyl radical having from 8 to 12 carbon atoms.

6. The composition of one of claims 3 to 5, characterized in that it comprises alkyl and/or alkenyl oligoglycosides of the formula II.
R⁵O—[G]ₚ (II)
in which R⁵ stands for an alkyl and/or alkenyl radical having 4 to 22 carbon atoms, g for a sugar radical having 5 or 6 carbon atoms, and p for numbers from 1 to 10, are present.

7. The composition of one of claims 3 to 6, characterized in that it comprises alkyl and/or alkenyl oligoglycosides of the formula (II) in which p stands for numbers from 1 to 3 and R⁵ stands for an alkyl radical having from 6 to 16 carbon atoms.

8. The composition of one of claims 3 to 7, characterized in that it comprises—calculated as active substance, based on the composition—from 0.01 to 25% by weight of hydroxy mixed ethers of the formula (I).

9. The composition of one of claims 3 to 8, characterized in that it comprises—calculated as active substance, based on the composition—from 0.01 to 30% by weight of alkyl and/or alkenyl oligoglycosides of the formula (II).

10. The composition of one of claims 3 to 9, characterized in that it comprises further nonionic surfactants preferably selected from the group formed by alkoxylates of alkanols, endgroup-capped alkoxylates of alkanols without free OH groups, alkoxylated fatty acid lower alkyl esters, and amine oxides.

11. The composition of claim 10, characterized in that it comprises—calculated as active substance, based on the composition—from 0.1 to 15% by weight of further nonionic surfactants.

12. The composition of one of claims 3 to 11, characterized in that it comprises as a further component anionic surfactants preferably selected from the group formed by alkyl and/or alkenyl sulfates, alkyl ether sulfates, alkylbenzene-sulfonates, monoglyceride (ether) sulfates, and alkanesulfonates.

13. The composition of claim 12, characterized in that it comprises—calculated as active substance, based on the composition—from 0.1 to 20% by weight of anionic surfactants.

14. The composition of one of claims 3 to 13, comprising
a. from 0.1 to 15% by weight—based on the composition—of surfactants comprising hydroxy mixed ethers of the formula (I)
b. from 5 to 90% by weight—based on the composition—of builders
c. from 0.1 to 6% by weight—based on the composition—of cleaning product enzyme
d. optionally from 0.1 to 40% by weight—based on the composition—of bleaches, and
e. further auxiliaries and additives.

15. The use of hydroxy mixed ethers of formula (I) in claim 1 in detergents and cleaning products.

16. The use of hydroxy mixed ethers of formula (I) in claim 1 for improving the wetting behavior in detergents and cleaning products.

17. The use of hydroxy mixed ethers of formula (I) in claim 1 for improving the plastics compatibility in detergents and cleaning products, especially in machine dishwashing detergents and/or rinse aids.

18. The use of hydroxy mixed ethers of formula (I) in claim 1 for the simplified preparation of solid cleaner formulations.
